(19) United States
(12) Patent Application Publication
(10) Pub. No.: US 2020/0198151 A1
(43) Pub. Date: Jun. 25, 2020

(54) ROBOT AND METHOD OF OPERATING THE SAME

(71) Applicant: KAWASAKI JUKOGYO KABUSHIKI KAISHA, Kobe-shi, Hyogo (JP)

(72) Inventors: Kazunori HIRATA, Yao-shi (JP); Masashi MISAWA, Kakogawa-shi (JP)

(73) Assignee: KAWASAKI JUKOGYO KABUSHIKI KAISHA, Kobe-shi, Hyogo (JP)

(21) Appl. No.: 16/500,444

(22) PCT Filed: Mar. 30, 2018
(86) PCT No.: PCT/JP2018/013577

§ 371 Date: Oct. 3, 2019

(30) Foreign Application Priority Data
Apr. 3, 2017 (JP) 2017-074061

(51) Int. Cl. B25J 11/00; B25J 9/00; B65G 47/04; B65G 59/06; B65G 15/00; B25J 15/00; B65B 3/04; B65B 43/46

(52) U.S. Cl. CPC B25J 11/0045; B25J 9/0093; B65G 47/04; B65B 43/46; B65G 15/00; B25J 15/0052; B65B 3/04; B65G 59/061

(57) ABSTRACT

A robot (11) of the present invention includes: a first arm (13A); and a controller configured to control operation of the first arm. The first arm includes a first hand (18) at a distal end thereof, the first hand including a first gripper (22) for gripping a container (42) and a second gripper (23) for gripping a discharger (32). The controller is configured to control the first arm to: grip the discharger by the second gripper; then, grip and obtain the container from a container provider (19) and place the obtained container on a conveying body (51) at a container placing position on a moving path of the conveying body by the first gripper; and at a food/drink material filling position downstream of the container placing position on the moving path of the conveying body, cause the discharger gripped by the second gripper to discharge a food/drink material into the container to fill the container with the food/drink material.

### TECHNICAL FIELD

The present invention relates to a robot and a method of operating the same.

### BACKGROUND ART

Conventionally, there are known techniques for automatically dispensing a drink or the like into a cup. For example, there is a proposed technique in which, in a drink dispenser, a cup that has fallen on a conveying belt is conveyed and stopped right below a nozzle, and a predetermined drink is dispensed from the nozzle into the cup (see Patent Literature 1, for example).

There is another proposed technique in which, in an automated drink system, a cup is conveyed by a cup conveyor by one cup holder position at a time, and a drink is dispensed into the cup at a drink dispensing station (see Patent Literature 2, for example).

### CITATION LIST

### Patent Literature

PTL 1: Japanese Laid-Open Patent Application Publication No. 2005-231716 (see, in particular, paragraphs [0037] to [0039] and FIG. 2)

PTL 2: Japanese Laid-Open Patent Application Publication No. 2010-163211 (see FIG. 1)

### SUMMARY OF INVENTION

### Technical Problem

In recent years, in various fields, it has been proposed that a robot and a worker should work together in the same working space in cooperation with each other in order to improve productivity. However, in the above-described conventional techniques, no robot is used for automatic drink dispensing into the cups. Here, the cups are merely one example of containers, and it is preferable to be able to automatically dispense a drink into the widest possible variety of containers. Also, the drink is merely one example of the following: a drink, a food having fluidity, and ingredients thereof (each of these will be referred to as a “food/drink material having fluidity” in the description below), and it is preferable to be able to automatically dispense the widest possible variety of food/drink materials having fluidity into the containers.

The present invention has been made to solve the above-described problems, and an object of the present invention is to provide a robot capable of automatically dispensing a food/drink material having fluidity into a container and a method of operating the robot.

### Solution to Problem

In order to solve the above-described problems, a robot according to one aspect of the present invention is a robot used in a food/drink material filling system for filling a container with a food/drink material having fluidity. The container has such a shape that a top portion of the container is open and a bottom portion of the container is closed. The food/drink material filling system includes: a conveying apparatus configured to move a conveying body to convey the container that is placed on the conveying body; a food/drink material feeder including a discharger configured to discharge the food/drink material; and a container provider for providing the container. The robot includes: a first arm; and a controller configured to control operation of the first arm. The first arm includes a first hand at a distal end thereof, the first hand including a first gripper for gripping the container and a second gripper for gripping the discharger. The controller is configured to control the first arm to: grip the discharger by the second gripper; then, grip and obtain the container from the container provider and place the obtained container on the conveying body at a container placing position on a moving path of the conveying body by the first gripper; and at a food/drink material filling position downstream of the container placing position on the moving path of the conveying body, cause the discharger gripped by the second gripper to discharge the food/drink material into the container to fill the container with the food/drink material. The food/drink material having fluidity herein means, as mentioned above, a drink, a food having fluidity, or ingredients thereof. In other words, the food/drink material having fluidity means a liquid, powdery, or granular drink or food, or ingredients thereof. Specific examples of the drink include water, milk, coffee, and tea. Specific examples of the food include a soup and a curry. Specific examples of the ingredients include seasoning, sauce, soy sauce, and any granular or powdery ingredients.

According to the above configuration, the first arm grips and obtains the container from the container provider by the first gripper, places the obtained container on the conveying body at the container placing position on the moving path of the conveying body, and at the food/drink material filling position downstream of the container placing position on the moving path of the conveying body, causes the discharger gripped by the second gripper to discharge the food/drink material into the container to fill the container with the food/drink material. In this manner, the food/drink material having fluidity can be automatically dispensed into the container.

The first hand may be configured such that: a discharge direction of the discharger gripped by the second gripper coincides with a direction of a predetermined axis; and a direction from the bottom portion to the top portion of the container gripped by the first gripper coincides with the direction of the predetermined axis.

According to the above configuration, as a result of merely controlling the first arm to cause the first hand to take such a posture that the predetermined axis coincides with the vertical direction, the container gripped by the first gripper faces in the upward direction, and the discharge direction of the discharger gripped by the second gripper is the downward direction. This makes it possible to readily perform a container placing and food/drink material filling operation.

The controller may be configured to control the first hand such that the first hand takes a container placing and food/drink material filling posture in which the predetermined axis coincides with a vertical direction, and when seen in the vertical direction, the container griped by the first gripper and the discharger gripped by the second gripper are positioned on a straight line on the conveying body, the straight line coinciding with a moving direction of the conveying body.

According to the above configuration, the container placed on the conveying body by the first gripper is conveyed by the conveying body to immediately below the discharger gripped by the second gripper. This makes it possible to properly fill the container with the food/drink material by the discharger.

The controller may be configured to control the first arm such that: the first hand in the container placing and food/drink material filling posture is lifted and lowered between a first height position and a second height position lower than the first height position; the first hand grips and obtains the container from the container provider by the first gripper at the first height position; and then, the first hand is lowered from the first height position to the second height position, and at the second height position, the first hand places the obtained container on the conveying body. According to this configuration, while the first hand is being lifted and lowered, the food/drink material is discharged into the container from the discharger gripped by the second gripper in accordance with the lifting and lowering of the first hand and the moving speed of the conveying body. Thus, by merely lifting and lowering the first hand, the container placing and food/drink material filling operation can be performed, and thereby the container placing and food/drink material filling operation can be simplified. This consequently makes it possible to increase the speed of the container placing and food/drink material filling operation.

The robot may further include a second arm that constitutes the container provider. The second arm may include, at a distal end thereof, a second hand for holding a container stack. The container may have an open top portion, a closed bottom portion, and such a shape that the container gets gradually thinner from the top portion to the bottom portion. The container stack may be a stack of a plurality of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed. The controller may be configured to control the first and second arms to grip and obtain each of the containers by the first hand of the first arm from the container stack held by the second hand of the second arm.

According to the above configuration, the second arm serves as the container provider. Thus, the configuration for providing each of the containers is simplified.

A method of operating a robot according to another aspect of the present invention is a method of operating a robot used in a food/drink material filling system for filling a container with a food/drink material having fluidity. The container has such a shape that a top portion of the container is open and a bottom portion of the container is closed. The food/drink material filling system includes: a conveying apparatus configured to move a conveying body to convey the container that is placed on the conveying body; a food/drink material feeder including a discharger configured to discharge the food/drink material; and a container provider for providing the container. The robot includes a first arm. The first arm includes a first hand at a distal end thereof, the first hand including a first gripper for gripping the container and a second gripper for gripping the discharger. The method includes: gripping the discharger by the second gripper; gripping and obtaining the container from the container provider by the first gripper; placing the obtained container on the conveying body at a container placing position on a moving path of the conveying body; and at a food/drink material filling position downstream of the container placing position on the moving path of the conveying body, causing the discharger gripped by the second gripper to discharge the food/drink material into the container to fill the container with the food/drink material.

According to the above configuration, the first arm grips and obtains the container from the container provider by the first gripper, places the obtained container on the conveying body at the container placing position on the moving path of the conveying body, and at the food/drink material filling position downstream of the container placing position on the moving path of the conveying body, causes the discharger gripped by the second gripper to discharge the food/drink material into the container to fill the container with the food/drink material. In this manner, the food/drink material having fluidity can be automatically dispensed into the container.

### Advantageous Effects of Invention

The present invention has an advantage of being able to provide a robot capable of automatically dispensing a food/drink material having fluidity into a container and a method of operating the robot.

### BRIEF DESCRIPTION OF DRAWINGS

FIG. 1 is a front view showing the configuration of a robot according to an embodiment of the present invention.

FIG. 2 is a perspective view showing the configurations of hands of the dual-arm robot of FIG. 1, the perspective view illustrating an application example (usage example) of the dual-arm robot.

FIG. 3A is a longitudinal sectional view schematically showing the structure of the center portion of a discharger of FIG. 1; FIG. 3B is a longitudinal sectional view showing a state where the discharger is gripped by a second gripper with a first pressure; and FIG. 3C is a longitudinal sectional view showing a state where the discharger is gripped by the second gripper with a second pressure.

FIG. 4 is a functional block diagram showing the configuration of a control system of the dual-arm robot of FIG. 1.

FIG. 5 is a flowchart showing a container placing and food/drink material filling operation of the dual-arm robot of FIG. 1.

FIG. 6 is a flowchart showing a container separating operation of the dual-arm robot of FIG. 1.

FIG. 7A is a perspective view showing an operation of the dual-arm robot of FIG. 1.

FIG. 7B is a perspective view showing an operation of the dual-arm robot of FIG. 1.

FIG. 7C is a perspective view showing an operation of the dual-arm robot of FIG. 1.

FIG. 7D is a perspective view showing an operation of the dual-arm robot of FIG. 1.

FIG. 7E is a perspective view showing an operation of the dual-arm robot of FIG. 1.

FIG. 8 is a schematic diagram showing another configuration example of a container stack.

### DESCRIPTION OF EMBODIMENTS

Hereinafter, an embodiment of the present invention is described with reference to the drawings. In the drawings, the same or corresponding elements are denoted by the same reference signs, and repeating the same descriptions is avoided below. The drawings show each component schematically in order to facilitate the understanding thereof. Therefore, some elements that are irrelevant to the present invention may be omitted from the drawings, and there are cases where some of the drawings do not match each other. Also, the dimensions of the elements shown in the drawings are not necessarily precise.

### Embodiment

### Configuration

<Configuration of Robot>

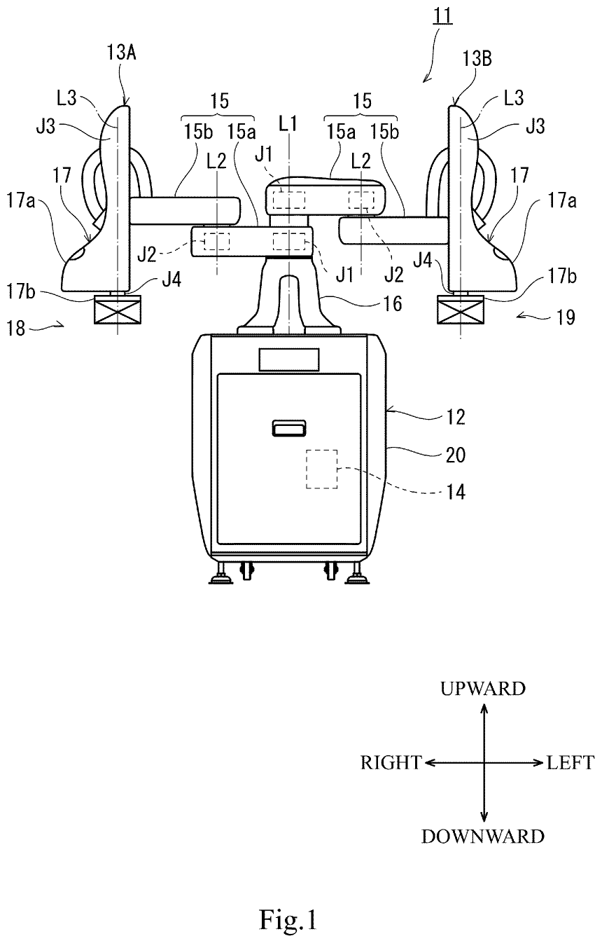

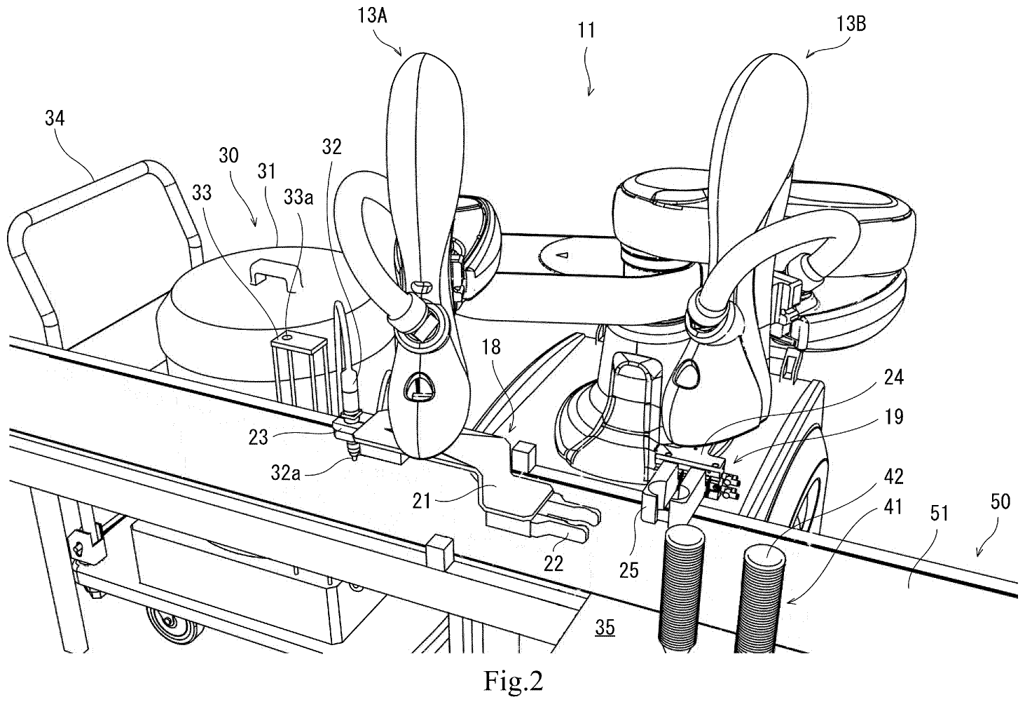

FIG. 1 is a front view showing the configuration of a robot according to the embodiment of the present invention. FIG. 2 is a perspective view showing the configurations of hands of the dual-arm robot of FIG. 1, the perspective view illustrating an application example (usage example) of the dual-arm robot.

With reference to FIG. 1 and FIG. 2, a robot 11 of the present embodiment includes a first arm 13A and a controller 14 configured to control the operations of the first arm 13A. The first arm 13A includes a first hand 18 at a distal end thereof. The first hand 18 includes: a first gripper 22 for gripping a container 42; and a second gripper 23 for gripping a discharger 32. Thus, the robot of the present embodiment is required to include at least one arm. It should be noted that in a case where the robot includes only one arm, it is necessary for a food/drink material filling system to include a container provider (see Other Embodiments below). In this example, the robot 11 further includes a second arm 13B, which constitutes a container provider. The second arm 13B includes, at a distal end thereof, a second hand 19 for holding a container stack 41.

Hereinafter, a specific configuration of the robot 11 is described. In the present embodiment, in FIG. 1, a direction in which a dual-arm robot 11 spreads a pair of arms thereof is referred to as a right-left direction; a direction parallel to the shaft center of a base shaft is referred to as an upward-downward direction; and a direction orthogonal to the right-left direction and the upward-downward direction is referred to as a front-rear direction.

With reference to FIG. 1, the dual-arm robot 11 includes: a base 12 fixed to a hand truck; the pair of arms (which may hereinafter be simply referred to as “arms”) 13A and 13B supported by the base 12; and the controller 14 accommodated in the base 12. The base 12 and the pair of arms 13A and 13B constitute the body of the dual-arm robot 11. Each of the arms 13A and 13B is a horizontal articulated arm configured to be movable relative to the base 12, and includes an arm part 15, a wrist part 17, and an end effector (18 or 19). It should be noted that the structure of the first arm (right arm) 13A and the structure of the second arm (left arm) 13B may be substantially the same as each other. The right arm 13A and the left arm 13B can be operated independently of each other, and also, can be operated in conjunction with each other. It should be noted that each of the arms 13A and 13B is only required to be a robotic arm, and is not limited to a horizontal articulated arm. For example, each of the arms 13A and 13B may be a general articulated arm. Also, the left arm may be the first arm, and the right arm may be the second arm.

In this example, the arm part 15 is constituted by a first link 15a and a second link 15b. The first link 15a is coupled by a rotary joint J1 to a base shaft 16, which is fixed to the upper surface of the base 12. The first link 15a is rotatable about a rotational axis L1, which extends through the shaft center of the base shaft 16. The second link 15b is coupled to the distal end portion of the first link 15a by a rotary joint J2. The second link 15b is rotatable about a rotational axis L2, which is defined at the distal end portion of the first link 1a.

The wrist part 17 is constituted by a lifting/lowering portion 17a and a rotating portion 17b. The lifting/lowering portion 17a is coupled to the distal end portion of the second link 15b by a prismatic joint J3. The lifting/lowering portion 17a is movable by being lifted/lowered relative to the second link 15b. The rotating portion 17b is coupled to the lower end of the lifting/lowering portion 17a by a rotary joint J4. The rotating portion 17b is rotatable about a rotational axis L3, which is defined at the lower end of the lifting/lowering portion 17a.

The end effectors (18 and 19) are coupled to the rotating portions 17b of the respective right and left wrist parts 17. The end effectors (18 and 19) are provided at the distal ends of the respective right and left arms 13. In this example, each of the end effectors (18 and 19) is configured as a hand. The configurations of the hands will be described below.

Each of the arms 13A and 13B configured as above includes the joints J1 to J4. Each of the arms 13 is provided with, for example: driving servomotors (not shown) corresponding to the respective joints J1 to J4; and encoders (not shown) configured to detect rotation angles of the respective servomotors. The rotational axes L1 of the respective first links 15a of the two arms 13A and 13B are positioned on the same straight line. The first link 15a of one arm 13 and the first link 15a of the other arm 13 are positioned at different heights such that they are displaced from each other in the upward-downward direction.

<Configuration of Hand>

With reference to FIG. 1 and FIG. 2, the first arm 13A includes the first hand 18 as an end effector. The first hand 18 includes a base portion 21, the first gripper 22, and the second gripper 23. The base portion 21 is a bent plate-shaped portion, and includes a first portion and a second portion. The first portion extends horizontally (perpendicularly to the rotational axis L3). The second portion extends downward from one end of the first portion, and then extends horizontally. The center of the first portion is fixed to the rotating portion 17b. The first gripper 22, which includes a pair of claws, is provided on the distal end of the second portion. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is constituted by a stiff body portion and an elastic layer covering the inner surface of the body portion. The stiff body portion is made of metal or resin, for example. The elastic layer is made of rubber or hard sponge, for example. Accordingly, when the pair of claws grips a container 42 in a sandwiching manner, the sandwiching force is applied to the container 42 in the horizontal direction, and in this manner, each of containers 42 of the container stack 41, in which the containers 42 are sequentially stacked upward, can be properly gripped. In addition, when the pair of claws grips the container 42 in the sandwiching manner, the elastic layers of the respective inner surfaces of the pair of claws are depressed, and friction force occurs between the container and the claws due to the elastic force of the elastic layers. As a result, the pair of claws can grip the container 42 without causing the container 42 to slip off the claws.

The second gripper 23, which includes a pair of claws, is formed on the other end of the first portion. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is made of a material such as metal or resin, for example.

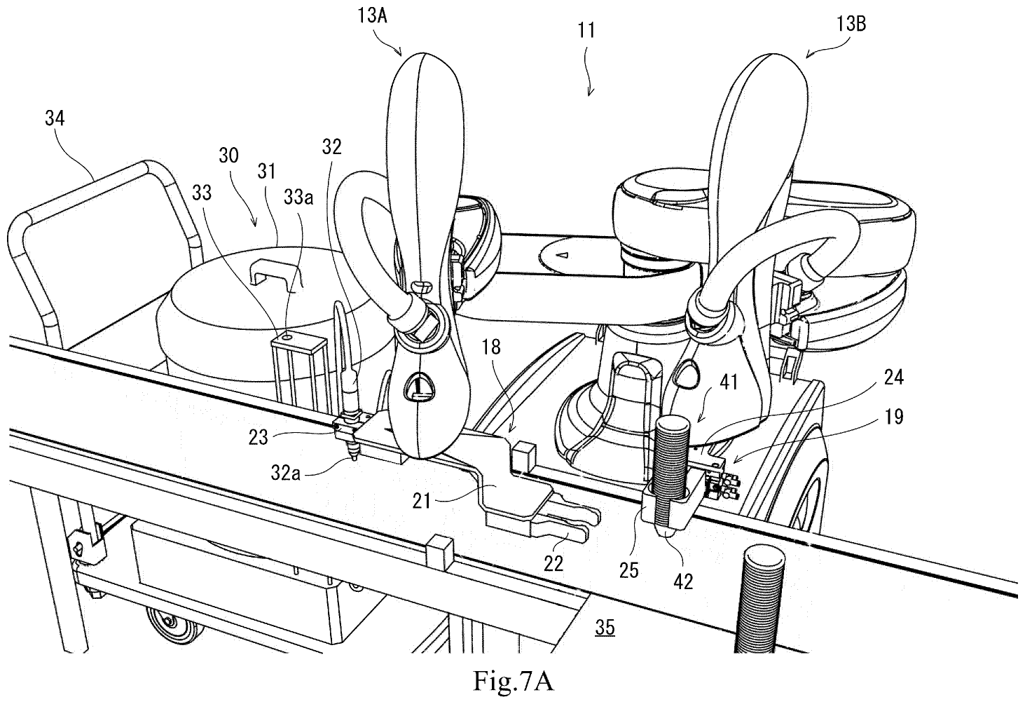

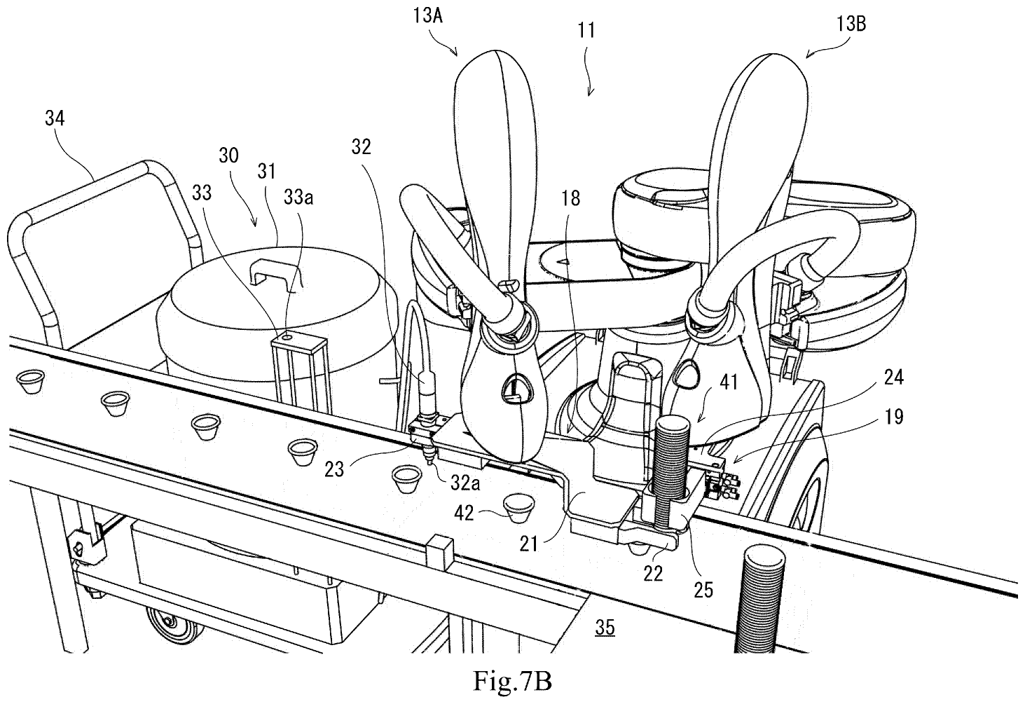

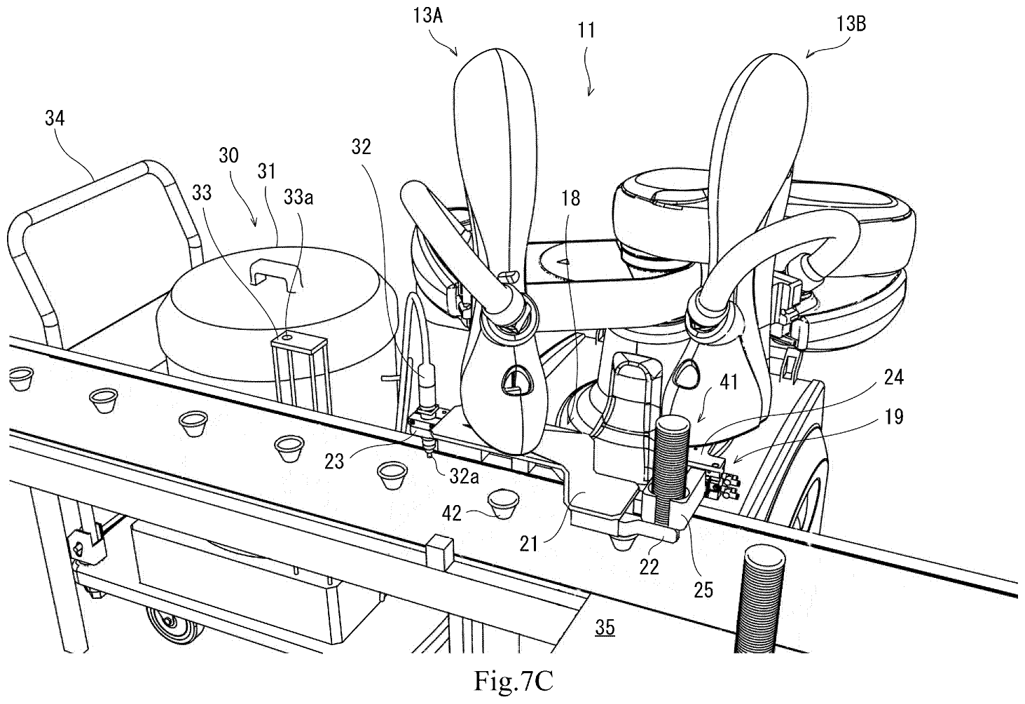

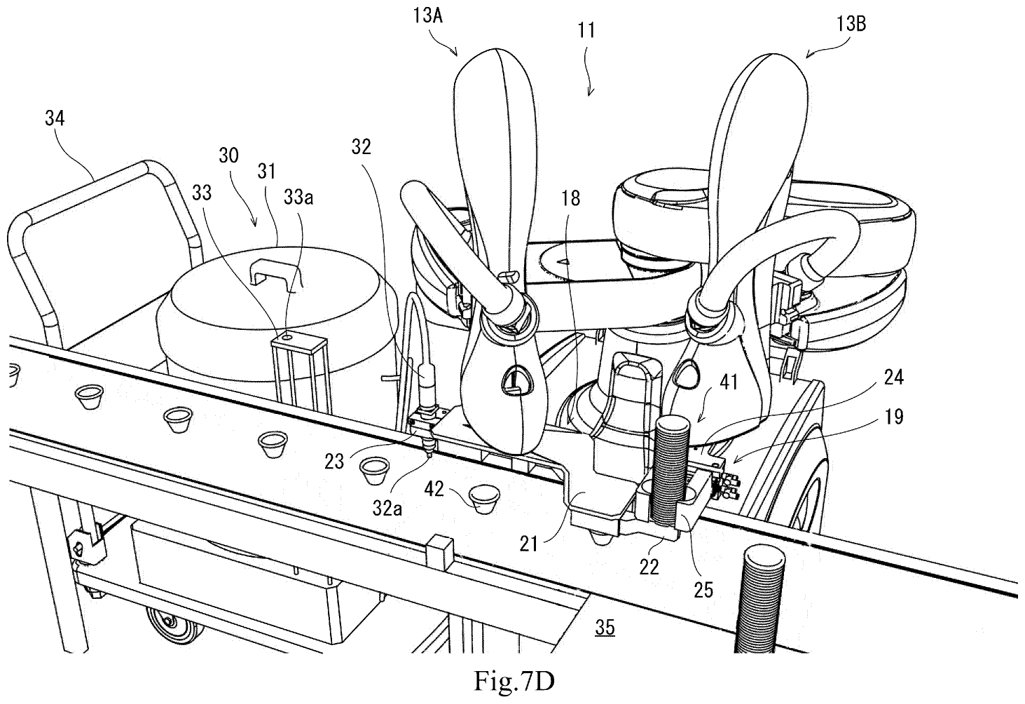

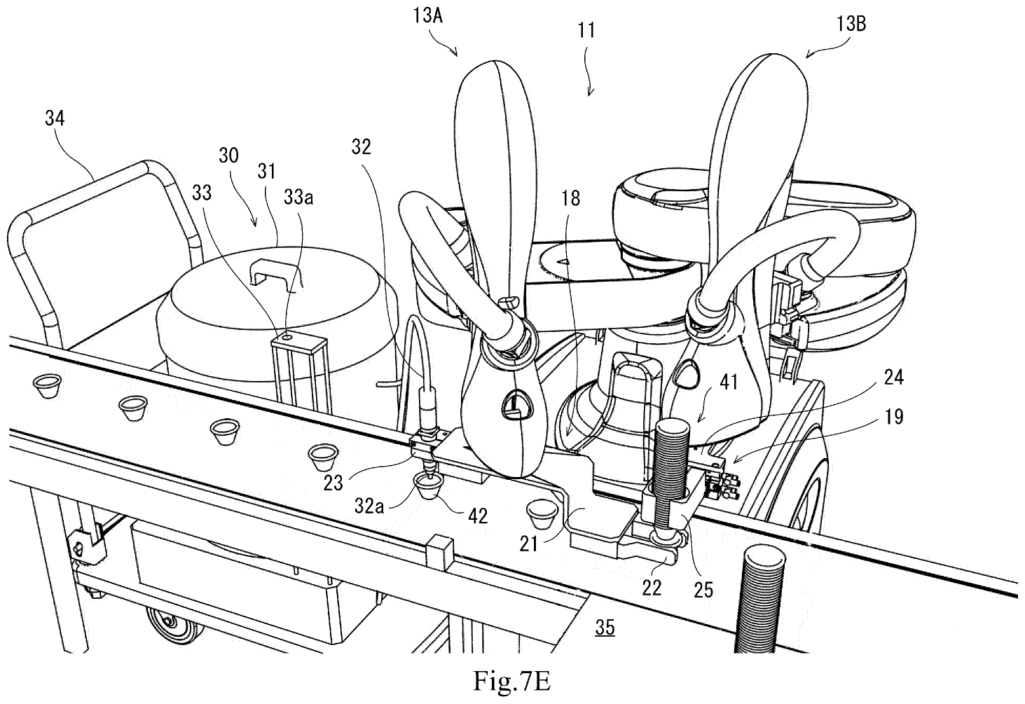

Each of the first gripper 22 and the second gripper 23 is configured as, for example, a chuck that is driven to open and close by air or a motor (in this example, air). It should be noted that, in each of FIG. 2 and FIGS. 7A to 7E, the pair of claws of the second gripper 23 appears to be fully closed. However, the pair of claws is configured not to be fully closed even when the pair of claws grips the discharger 32 with either a first pressure or a second pressure. The first pressure and the second pressure will be described below.

In the above configuration, the discharge direction of the discharger 32 gripped by the second gripper 23 of the first hand 18 of the first arm 13A coincides with the direction of the rotational axis L3, and the direction from the bottom portion to the top portion of the container 42 gripped by the first gripper 22 coincides with the direction of the rotational axis L3 (see FIG. 7E). According to this configuration, since the rotational axis L3 coincides with the vertical direction, even when the first arm is not controlled, the container 42 gripped by the first gripper 22 faces in the upward direction, and the discharge direction of the discharger 32 gripped by the second gripper 23 is the downward direction. This makes it possible to readily perform a container placing and food/drink material filling operation.

The second arm 13B includes the second hand 19 as an end effector. The second hand 19 includes a base portion 24 and a gripper 25. The base portion 24 is a flat plate-shaped portion, and one end thereof is fixed to the rotating portion 17b. The gripper 25, which includes a pair of claws, is provided on the other end of the base portion 24. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is constituted by a stiff body portion and an elastic layer covering the inner surface of the body portion. The stiff body portion is made of metal or resin, for example. The elastic layer is made of rubber or hard sponge, for example. Accordingly, when the pair of claws grips a container 42 in a sandwiching manner, the sandwiching force is applied to the container 42 in the horizontal direction, and in this manner, each of the containers 42 of the container stack 41, in which the containers 42 are sequentially stacked upward, can be properly gripped. In addition, when the pair of claws grips the container 42 in the sandwiching manner, the elastic layers of the respective inner surfaces of the pair of claws are depressed, and friction force occurs between the container and the claws due to the elastic force of the elastic layers. As a result, the pair of claws can grip the container 42 without causing the container 42 to slip off the claws.

In the above configuration, the direction from the bottom portion to the top portion of the container 42 of the container stack 41 gripped by the gripper 25 of the second hand 19 of the second arm 13B coincides with the direction of the rotational axis L3 (i.e., the vertical direction) (see FIG. 7E).

The width (i.e., the dimension in the upward-downward direction) of the gripper 25 of the second arm 13B is greater than the width of the first gripper 22 of the first arm 13A. The reason for this is to allow the gripper 25 of the second arm 13B to stably hold the container stack 41 since the container stack 41 is held mainly by the gripper 25. The gripper 25 of the second arm 13B is configured as, for example, a chuck that is driven to open and close by air or a motor (in this example, air).

<Configuration of Control System>

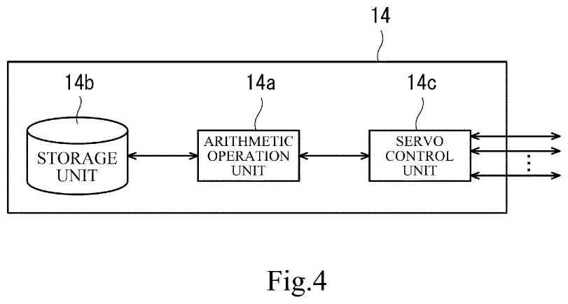

FIG. 4 is a functional block diagram schematically showing the configuration of a control system of the dual-arm robot 11. As shown in FIG. 4, the controller 14 includes an arithmetic operation unit (processor) 14a, a storage unit 14b, and a servo control unit 14c. The controller 14 is configured as, for example, a microcontroller, an MPU, an FPGA (Field Programmable Gate Array), or a PLC (Programmable Logic Controller). The arithmetic operation unit 14a is configured as, for example, a processor of a microcontroller or the like. The storage unit 14b is configured as a memory of, for example, the microcontroller. The controller 14 may be configured as a single controller performing centralized control, or may be configured as a plurality of controllers performing distributed control in cooperation with each other.

The storage unit 14b stores a basic program as a robot controller program and information such as various fixed data. The arithmetic operation unit 14a controls various operations of the dual-arm robot 11 by loading and executing, for example, the basic program stored in the storage unit 14b. Specifically, the arithmetic operation unit 14a generates a control command for the dual-arm robot 11, and outputs the generated control command to the servo control unit 14c. The servo control unit 14c is configured to control the driving of the servomotors corresponding to the joints J1 to J4 of each of the arms 13 of the dual-arm robot 11 based on the control command generated by the arithmetic operation unit 14a. The controller 14 also controls the operations of the first gripper 22 and the second gripper 23 of the first hand 18 and the operations of the gripper 25 of the second hand. Thus, the controller 14 controls the operations of the overall dual-arm robot 1.

### Application Example

Next, an application example (usage example) of the dual-arm robot 11 configured as above is described with reference to FIG. 2.

<Working Site>

With reference to FIG. 2, the dual-arm robot 11 is applied to, for example, a food/drink material filling system for filling containers 42 with a food/drink material having fluidity (a food, a drink, or ingredients thereof). That is, the food/drink material filling system is a working site where the dual arm robot 11 works. At the working site, a conveying apparatus 50 is installed, which is configured to move a conveying body 51 to convey an object (in this example, a container 42) placed on the conveying body 51. In this example, the conveying body 51 is a belt, and the conveying apparatus 50 is a belt conveyor. Necessary equipment, tools, workers, etc., for performing the work are arranged on both sides of the conveying body 51. The dual-arm robot 11 is a machine for automatically placing the container 42 on the conveying body 51 and filling the container 42 placed on the conveying body 51 with the food/drink material. In this example, the food/drink material is a dressing. As shown in FIG. 2, the dual-arm robot 11 can be installed in a limited space that is in the size of one person (e.g., 610 mm×620 mm). A food/drink material feeder 30 is disposed on the right side of the dual-arm robot 11. The food/drink material feeder 30 is placed on a hand truck 34. Thus, the food/drink material feeder 30 for feeding the food/drink material, with which to fill the containers 42, is placed on the hand truck 34, and a worker carries the food/drink material feeder 30 with the hand truck 34 and positions the food/drink material feeder 30 at a predetermined position. The food/drink material feeder 30 includes a food/drink material tank 31, the discharger 32, and a discharger stand 33. The food/drink material tank 31 stores therein the food/drink material having fluidity. The discharger 32 includes an inlet provided at its proximal end portion, and the inlet is connected to the food/drink material tank 31 by a feed pipe. The discharger 32 also includes a discharge outlet 32a provided at its distal end portion. The discharger stand 33 is provided at a suitable position on the food/drink material feeder 30. A placing board is disposed on the top of the discharger stand 33, and a through-hole 33a is formed in the placing board. The discharger 32 is carried in the state of being inserted in the through-hole 33a, with the discharge outlet 32a facing downward. When the work of filling the containers 42 with the food/drink material is started, the discharger 32 is gripped by the second gripper 23 of the first hand 18 of the first arm 13A of the dual-arm robot 11. At the time, the second gripper 23 grips the center portion of the discharger 32.

Meanwhile, a container stand 35 is disposed in front of the conveying body 51 near the first arm of the dual-arm robot 11. A plurality of container stacks 41 are arranged on the container stand 35 at their predetermined positions.

<Configuration Relating to Discharging of Food/Drink Material>

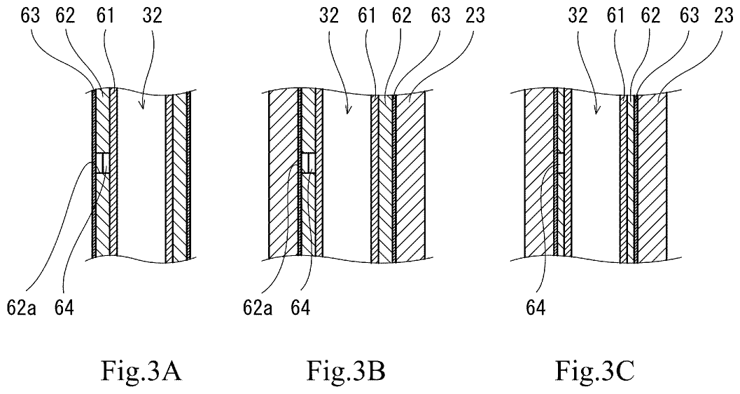

With reference to FIG. 2, the food/drink material feeder 30 includes: a pressure feeder (not shown) configured to pressure-feed the food/drink material having fluidity; an open/close valve (not shown) provided on a food/drink material feed passage extending from the food/drink material tank 31 to the discharger 32; a controller (not shown) configured to control the operations of the pressure feeder and the open/close valve; and a pressure sensor 64 (see FIG. 3). A pressure detected by the pressure sensor 64 is transmitted to the controller. The controller is configured to: close the open/close valve when the pressure detected by the pressure sensor 64 is lower than a predetermined pressure threshold; and open the open/close valve when the pressure detected by the pressure sensor 64 is higher than or equal to the predetermined pressure threshold. The pressure sensor 64 is constituted by, for example, a piezoelectric element. For example, if the food/drink material is a liquid material, the pressure feeder is configured as a pump, and if the food/drink material is a powdery or granular material, the pressure feeder is configured as an air blower. In this example, the pressure feeder is started/stopped in accordance with the opening/closing of the open/close valve.

With reference to FIG. 1 and FIG. 2, the controller 14 controls the second gripper 23, such that the second gripper 23 grips the discharger 32 selectively with the first pressure and the second pressure. The first pressure is lower than the aforementioned predetermined pressure threshold, and with the first pressure, the discharger 32 can be stably gripped. The second pressure is higher than or equal to the predetermined pressure threshold, and gripping the discharger 32 with the second pressure causes the discharger 32 to discharge the food/drink material.

FIG. 3A is a longitudinal sectional view schematically showing the structure of the center portion of the discharger 32 of FIG. 1. FIG. 3B is a longitudinal sectional view showing a state where the discharger 32 is gripped by the second gripper 23 with the first pressure. FIG. 3C is a longitudinal sectional view showing a state where the discharger 32 is gripped by the second gripper 23 with the second pressure.

With reference to FIG. 3A, overall, the discharger 32 has a cylindrical shape. The discharger 32 includes: a cylindrical body 61; an elastic layer 62 covering the outer surface of the body 61; and a coating layer 63 covering the outer surface of the elastic layer 62. The body 61 is made of a stiff material. The stiff material is a metal or synthetic resin, for example. The elastic layer 62 is made of rubber or hard sponge, for example. The coating layer 63 is made of a thin flexible material. The thin flexible material is a plastic film, for example.

A through-hole 62a is formed in the elastic layer 62. The pressure sensor 64 is installed in the through-hole 62a. The bottom surface of the pressure sensor 64 is fixed to the body 61, and the top surface of the pressure sensor 64 is positioned at about half the depth of the through-hole 62a.

The elasticity and thickness of the elastic layer are set such that, as described below, when the second gripper 23 grips the discharger 32 with the second pressure, the pressure detected by the pressure sensor 64 is higher than or equal to the predetermined pressure threshold. The elasticity and thickness of the elastic layer 62 and the predetermined pressure threshold are set based on, for example, calculation, experiment, or simulation.

With reference to FIG. 3B, when the second gripper 23 grips the discharger 32 with the first pressure, the elastic layer 62 is slightly compressed, but the pressure sensor 64 is not pressed by the second gripper 23. Accordingly, the food/drink material is not discharged from the discharge outlet 32a of the discharger 32.

With reference to FIG. 3C, when the second gripper 23 grips the discharger 32 with the second pressure, the elastic layer 62 is compressed to such a thickness that the coating layer 63 comes into contact with the pressure sensor 64. In this manner, the pressure sensor 64 is pressed by the second gripper 23 via the coating layer 63 with a pressure that is higher than or equal to the predetermined pressure threshold. Consequently, the aforementioned open/close valve is opened and the pressure feeder is started, and thereby the food/drink material is discharged from the discharge outlet 32a of the discharger 32.

<Container Stack>

Each of the containers 42 is required to have an open top portion, a closed bottom portion, and such a shape that each container 42 gets gradually thinner from the top portion to the bottom portion. In this example, each container 42 is a cup.

Each of the container stacks 41 is a stack of the containers that are sequentially stacked such that every two containers adjacent to each other in the upward-downward direction in the stack are arranged in such a manner that the upper one of the two containers is inserted from its bottom portion into the internal space of the lower one of the two containers, such that the top portion of the upper container is exposed. In other words, each container stack 41 is formed by stacking the containers 42 in a non-inverted manner. The “non-inverted” stacking herein is the opposite of “inverted” stacking, and the “non-inverted” stacking means that each container 42 in the stack is in such an orientation that the direction from the bottom portion to the top portion of the container 42 is the upward direction.

### Operation Examples

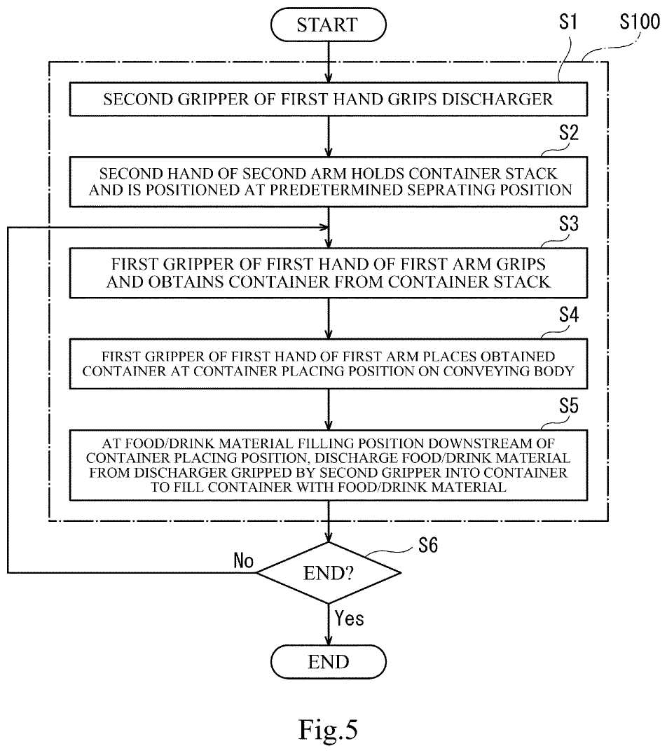

Next, operations of the dual-arm robot configured as above are described based on FIG. 2, FIG. 5, and FIGS. 7A to 7E. The operations are performed as a result of the controller 14 controlling the dual-arm robot 11. FIG. 5 is a flowchart showing the container placing and food/drink material filling operation of the dual-arm robot 11 of FIG. 1. FIGS. 7A to 7E are perspective views showing the operations of the dual-arm robot of FIG. 1. It should be noted that, hereinafter, for the purpose of simplifying the description, an operation of “a gripper of a hand” may be expressed as an operation of “a hand (gripper)”.

<Container Placing and Food/Drink Material Filling Operation>

As shown in FIG. 2, when the work of filling the containers 42 with the food/drink material is started, the first arm 13A of the dual-arm robot 11 grips, by the second gripper 23 with the first pressure, the center portion of the discharger 32 placed on the discharger stand 33 (step S1). Thereafter, the first hand 18 of the first arm 13A takes a container placing and food/drink material filling posture in which, when seen in the vertical direction, a container 42 gripped by the first gripper 22 (in FIG. 2, the container 42 is not yet gripped) and the discharger 32 gripped by the second gripper 23 are positioned on a straight line on the conveying body 51, the straight line coinciding with the moving direction of the conveying body 51. Specifically, the first hand 18 takes such a posture that, when seen in a plan view, the first gripper 22 is positioned at a container placing position on the moving path of the conveying body 51, and the discharge outlet 32a of the discharger 32 gripped by the second gripper 23 is positioned at a food/drink material filling position on the moving path of the conveying body 51. When seen in a plan view, the container placing position and the food/drink material filling position are positioned on the straight line that coincides with the moving direction of the conveying body 51, and the food/drink material filling position is positioned downstream of the container placing position. The moving speed of the conveying body 51 is set to a predetermined speed. In this state, the dual-arm robot 11 performs the container placing and food/drink material filling operation as described below.

First, as shown in FIG. 7A, the second hand 19 (gripper 25) of the second arm 13B holds a container stack 41, and is positioned at a predetermined separating position (step S2).

Next, as shown in FIG. 7B to FIG. 7E, the first gripper 22 of the first hand 18 of the first arm 13A grips and obtains a container 42 from the container stack 41 (step S3).

Next, as shown in FIG. 7E, the first gripper 22 of the first hand 18 of the first arm 13A places the obtained container 42 at the container placing position on the conveying body 51 (step S4).

At the food/drink material filling position downstream of the container placing position, the second gripper 23 grips the discharger 32 with the second pressure, thereby causing the discharger 32 to discharge the food/drink material from the discharge outlet 32a into the container 42 to fill the container 42 with the food/drink material (step S5). In this case, after the food/drink material is discharged for a predetermined period of time, the second gripper 23 grips the discharger 32 with the first pressure. As a result, the discharging of the food/drink material from the discharge outlet 32a is stopped. Here, step S4 and step S5 may be performed at the same time or at different times. In this example, step S4 and step S5 are performed at the same time. For this reason, a duration of time (a cycle time) over which the container 42 is placed at the container placing position on the conveying body 51 is set to 1/(integer) of a time over which the container 42 is moved between the container placing position and the food/drink material filling position (in this example, ½). Accordingly, in this example, a container 42 previously placed at the container placing position on the conveying body 51 two cycle times earlier is positioned at the food/drink material filling position during the current cycle time. Therefore, during the current cycle time, the operation of placing a new container 42 at the container placing position on the conveying body 51, and the operation of filling the container 42 previously placed at the container placing position on the conveying body 51 two cycle times earlier with the food/drink material at the food/drink material filling position, can be performed at the same time.

After steps S4 and S5, the controller 14 determines whether or not to end the container placing and food/drink material filling operation (step S6). If the controller 14 determines not to end the container placing and food/drink material filling operation (NO in step S6), the controller 14 returns to step S3. If the controller 14 determines to end the container placing and food/drink material filling operation (YES in step S6), the controller 14 ends the container placing and food/drink material filling operation.

<Container Separating (Container Placing) Operation>

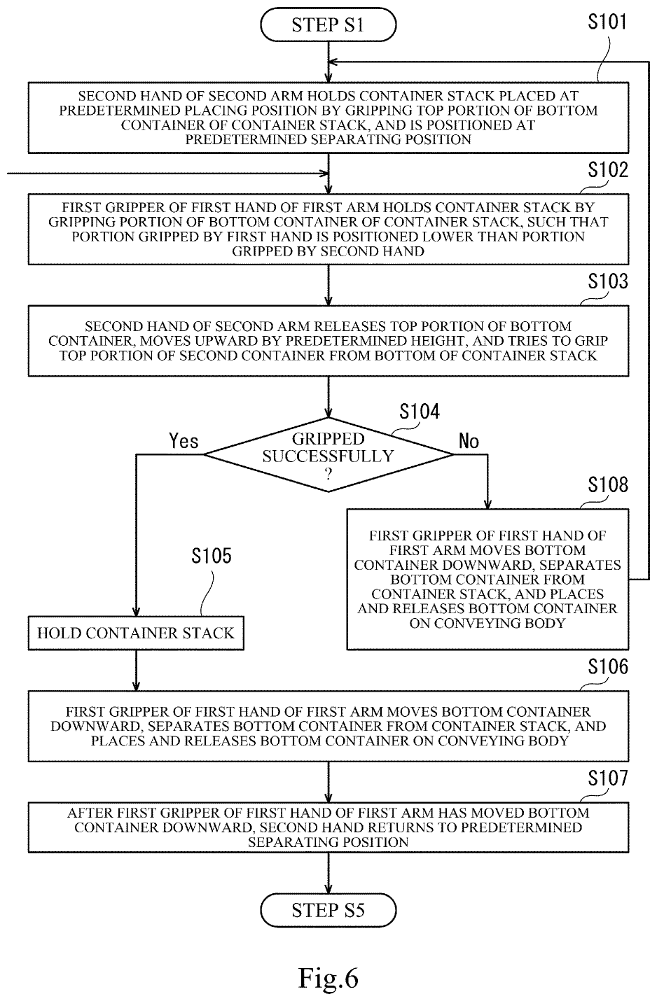

Next, a container separating (container placing) operation (steps S2 to S4) in the flowchart of FIG. 5 is described in detail by using FIG. 2, FIG. 6, and FIGS. 7A to 7E. FIG. 6 is a flowchart showing the container separating operation of the dual-arm robot of FIG. 1.

After step 51 of FIG. 5 is performed, as shown in FIG. 2 and FIG. 7A, the second hand 19 (gripper 25) of the second arm 13B holds the container stack 41, which is placed at its predetermined placing position on the container stand 35, by gripping the top portion of the bottom one of the containers 42 of the container stack 41, and is positioned at the predetermined separating position (step S101). The separating position is a position immediately above the container placing position.

Next, as shown in FIG. 7B, the first hand 18 (first gripper 22) of the first arm 13A starts moving upward.

Next, as shown in FIG. 7C, the first hand 18 (first gripper 22) of the first arm 13A holds the container stack 41 by gripping a portion of the bottom container 42 of the container stack 41, such that the portion gripped by the first hand 18 (first gripper 22) is positioned lower than the portion gripped by the second hand 19 (gripper 25) (step S102).

Next, as shown in FIG. 7D, the second hand 19 (gripper 25) of the second arm 13B releases the top portion of the bottom container 42 (step S103).

Next, the second hand 19 (gripper 25) of the second arm 13B moves upward by a predetermined height, and tries to grip the top portion of the second container 42 from the bottom of the container stack 41 (step S104). Here, since the second container 42 is present above the bottom container 42, the second hand 19 (gripper 25) of the second arm 13B grips the top portion of the second container 42 successfully (YES in step S104).

Then, as shown in FIG. 7E, the second hand 19 (gripper 25) of the second arm 13B holds the container stack 41 (step S105).

Next, as shown in FIG. 7E, the first hand 18 (first gripper 22) of the first arm 13A moves the bottom container 42 downward, separates the bottom container 42 from the container stack 41, and places and releases the bottom container 42 on the conveying body 51 (step S106).

Next, as shown in FIG. 7E, after the first hand 18 (first gripper 22) of the first arm 13A has moved the bottom container 42 downward, the second hand 19 (gripper 25) returns to the predetermined separating position (step S107).

In step S4, if no container 42 is present above the bottom container 42, i.e., if the container 42 currently gripped by the first hand 18 (first gripper 22) of the first arm is the top container (i.e., the last container) of the container stack 41, then the try to grip the second container from the bottom of the container stack 41 fails (NO in step S104). In this case, in the container separating operation, the first hand 18 (first gripper 22) of the first arm moves the bottom container 42 downward, separates the bottom container 42 from the container stack 41, and places and releases the bottom container 42 on the conveying body 51 (step S109). Thereafter, returning to step S101, the second hand (gripper 25) grips the next container stack 41, and is positioned at the separating position.

After step S107, step S4 of FIG. 5 is performed.

As described above, according to the present embodiment, the first arm 18A grips and obtains a container 42 by the first gripper 22 from the second arm 13B serving as the container provider, and places the obtained container 42 on the conveying body 51 at the container placing position on the moving path of the conveying body 51. Then, at the food/drink material filling position downstream of the container placing position on the moving path of the conveying body 51, the food/drink material is discharged into the container 42 from the discharger 32 gripped by the second gripper 23 to fill the container 42 with the food/drink material. In this manner, the food/drink material having fluidity can be automatically dispensed into the container 42.

### Variations

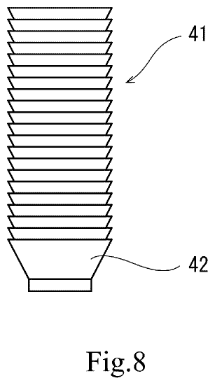

FIG. 8 is a schematic diagram showing another configuration example of the container stack 41. With reference to FIG. 8, in this variation, each of the containers 42 is a tea bowl. A plurality of the tea bowls 42 are sequentially stacked such that every two tea bowls 42 adjacent to each other in the upward-downward direction in the tea bowl stack are stacked in such a manner that the upper one of the two tea bowls 42 is inserted from its bottom portion into the internal space of the lower one of the two tea bowls 42, such that the top portion of the upper tea bowl 42 is exposed.

According to the dual-arm robot 11 of the present embodiment, also when the container stack is the above-described tea bowl stack 41, the container separating operation can be properly performed, and thereby automatic feeding of the tea bowls 42 can be performed.

### Other Embodiments

In the above-described embodiment, the robot 11 may include only one robotic arm. In this case, the food/drink material filling system includes a container provider, and the container provider is disposed near the robot 11. The robot 11 obtains a container 42 from the container provider by the robotic arm, and places the obtained container 42 on the conveying body 51. Any known container provider can be used as the container provider of the food/drink material filling system. For example, any of those disclosed in Patent Literatures 1 and 2 can be used as the container provider. Alternatively, a belt conveyor may be used as the container provider. In this case, each of the containers is required to have an open top portion and a closed bottom portion.

In the above-described embodiment, the dual-arm robot 11 may hold any suitable container provider by the second arm 13B, and the first arm 13A may obtain the container 42 from the container provider.

The discharger 32 may be formed to have a cylindrical shape and elasticity. Normally, the second gripper 23 may grip the discharger 32 with a predetermined pressure, and the discharger 32 may be configured to discharge the food/drink material from the discharge outlet 32a when the second gripper 23 strongly grips the discharger 32.

The containers are not limited to the above-described examples, but may be trays, bowls, dishes, etc.

The working site is not limited to a working site relating to food products, but may be a different kind of working site, so long as the working site is a site where a robot and a worker work together in the same working space in cooperation with each other.

From the foregoing description, numerous modifications and other embodiments of the present invention are obvious to a person skilled in the art. Therefore, the foregoing description should be interpreted only as an example and is provided for the purpose of teaching the best mode for carrying out the present invention to a person skilled in the art. The structural and/or functional details may be substantially altered without departing from the spirit of the present invention.

### INDUSTRIAL APPLICABILITY

The robot and the method of operating the same according to the present invention are useful as a robot capable of automatically dispensing a food/drink material having fluidity into a container and a method of operating the robot.

### REFERENCE SIGNS LIST

11 dual-arm robot

12 base

13A first arm

13B second arm

14 controller

14a arithmetic operation unit (processor)

14b storage unit

14c servo control unit

15 arm part

15a first link

15b second link

16 base shaft

17 wrist part

17a lifting/lowering portion

17b rotating portion

18 first hand (end effector)

19 second hand (end effector)

21 base portion

22 first gripper

23 second gripper

24 base portion

25 gripper

30 food/drink material feeder

31 food/drink material tank

32 discharger

32a discharge outlet

33 discharger stand

33a through-hole

34 hand truck

35 container stand

41 container

42 container stack

50 conveying apparatus

51 conveying body

61 body

62 elastic layer

62a through-hole

63 coating layer

64 pressure sensor

1. A robot used in a food/drink material filling system for filling a container with a food/drink material having fluidity,
the container having such a shape that a top portion of the container is open and a bottom portion of the container is closed,
the food/drink material filling system including:
a conveying apparatus configured to move a conveying body to convey the container that is placed on the conveying body;
a food/drink material feeder including a discharger configured to discharge the food/drink material; and
a container provider for providing the container,
the robot comprising:
a first arm; and
a controller configured to control operation of the first arm, wherein
the first arm includes a first hand at a distal end thereof, the first hand including a first gripper for gripping the container and a second gripper for gripping the discharger, and
the controller is configured to control the first arm to:
grip the discharger by the second gripper;
then, grip and obtain the container from the container provider and place the obtained container on the conveying body at a container placing position on a moving path of the conveying body by the first gripper; and
at a food/drink material filling position downstream of the container placing position on the moving path of the conveying body, cause the discharger gripped by the second gripper to discharge the food/drink material into the container to fill the container with the food/drink material.

2. The robot according to claim 1, wherein
the first hand is configured such that:
a discharge direction of the discharger gripped by the second gripper coincides with a direction of a predetermined axis; and
a direction from the bottom portion to the top portion of the container gripped by the first gripper coincides with the direction of the predetermined axis.

3. The robot according to claim 2, wherein
the controller is configured to control the first hand such that the first hand takes a container placing and food/drink material filling posture in which the predetermined axis coincides with a vertical direction, and when seen in the vertical direction, the container griped by the first gripper and the discharger gripped by the second gripper are positioned on a straight line on the conveying body, the straight line coinciding with a moving direction of the conveying body.

4. The robot according to claim 3, wherein
the controller is configured to control the first arm such that:
the first hand in the container placing and food/drink material filling posture is lifted and lowered between a first height position and a second height position lower than the first height position;
the first hand grips and obtains the container from the container provider by the first gripper at the first height position; and
then, the first hand is lowered from the first height position to the second height position, and at the second height position, the first hand places the obtained container on the conveying body.

5. The robot according to claim 1, further comprising a second arm that constitutes the container provider, wherein
the second arm includes, at a distal end thereof, a second hand for holding a container stack,
the container has an open top portion, a closed bottom portion, and such a shape that the container gets gradually thinner from the top portion to the bottom portion,
the container stack is a stack of a plurality of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed, and
the controller is configured to control the first and second arms to grip and obtain each of the containers by the first hand of the first arm from the container stack held by the second hand of the second arm.

6. A method of operating a robot used in a food/drink material filling system for filling a container with a food/drink material having fluidity,
the container having such a shape that a top portion of the container is open and a bottom portion of the container is closed,
the food/drink material filling system including:
a conveying apparatus configured to move a conveying body to convey the container that is placed on the conveying body;
a food/drink material feeder including a discharger configured to discharge the food/drink material; and
a container provider for providing the container,
the robot including a first arm,
the first arm including a first hand at a distal end thereof, the first hand including a first gripper for gripping the container and a second gripper for gripping the discharger,
the method comprising:
gripping the discharger by the second gripper;
gripping and obtaining the container from the container provider by the first gripper;
placing the obtained container on the conveying body at a container placing position on a moving path of the conveying body; and
at a food/drink material filling position downstream of the container placing position on the moving path of the conveying body, causing the discharger gripped by the second gripper to discharge the food/drink material into the container to fill the container with the food/drink material.
